(19) United States
(12) Patent Application Publication
(10) Pub. No.: US 2014/0092304 A1
(43) Pub. Date: Apr. 3, 2014

(54) TV AND WIRELESS ELECTRONIC DEVICE COMBINATION SYSTEM

(71) Applicant: Shih-Yao CHEN, New Taipei City (TW)

(72) Inventor: Shih-Yao CHEN, New Taipei City (TW)

(21) Appl. No.: 13/633,319

(22) Filed: Oct. 2, 2012

(51) Int. Cl. H04N 7/00

(52) U.S. Cl. 348/552; 348/E07.001

(57) ABSTRACT

A TV and wireless electronic device combination system includes a TV monitor having set therein a TV display system, a wireless electronic device, a data stream connected between the wireless electronic device and the TV display system of the TV monitor using Wi-Fi (Wireless Fidelity) or data packet transmission technology. The TV display system includes a CPU for processing data stream, and a mirror image transmission device for feeding back mirror image picture to the wireless electronic device.

### BACKGROUND OF THE INVENTION

1. Field of the Invention

The present invention relates to wireless TV technology and more particularly, to a TV and wireless electronic device combination system, which comprises a TV monitor having set therein a TV display system, a wireless electronic device, and a data stream connected between the wireless electronic device and the TV display system of the TV monitor using Wi-Fi (Wireless Fidelity) or data packet transmission technology.

2. Description of the Related Art

Mobile electronic devices have become requisites of many people either at home or outdoors. The functions and forms of these mobile electronic devices change rapidly. Related technology has been continuously developing.

Nowadays, touch panel technology has been intensively used in home TV and other mobile electronic devices to substitute for conventional display screens. By means of touching the touchscreen of a mobile electronic device with a finger, the user can operate the mobile electronic device rapidly and conveniently.

Further, the display screen of a mobile electronic device has a limited size, for example, a large smart phone uses a 5.5 inches display screen, a regular tablet PC uses a 7 inches display screen. It is not comfortable to watch a video on the display screen of a mobile electronic device for a long period of time. Few people use a mobile electronic device to watch videos.

Further, home TV monitors range from 32 inches to 50 inches. Either in image clarity or magnificent feeling, the small display screens of mobile electronic devices are not comparable to TV display screens.

Unless of the use of related auxiliary equipment, a smart phone, tablet PC or mobile electronic device user can only watch downloaded videos on a small display screen. Watching videos on a small display screen is not comfortable like watching a large size home TV screen. Further, conventional LCD TVs do not allow transmission of real time videos to a mobile electronic device.

Commercial mobile electronic devices allow a user to input storage videos into a home LCD TV for playing using a specifically designed cable. However, it is inconvenient to transmit videos from a mobile electronic device to a home LCD TV using a cable. Further, a cable of this kind is quite expansive. Because of cost considerations, user may give up buying such a cable. An improvement in this regard is necessary.

### SUMMARY OF THE INVENTION

The present invention has been accomplished under the circumstances in view. It is the main object of the present invention to provide a TV and wireless electronic device combination system, which establishes communication between a TV monitor and a wireless electronic device, such as smart phone, tablet PC or notebook, using a Wi-Fi (Wireless Fidelity) or data packet transmission data stream.

It is another object of the present invention to provide a TV and wireless electronic device combination system, which uses a cost-effective built-in structure for Wi-Fi (Wireless Fidelity) or data packet transmission, facilitating operation.

It is still another object of the present invention to provide a TV and wireless electronic device combination system, which has a mirror image transmission device incorporated into the TV display system so that the mirror image picture of the TV monitor can be fed back to the smart phone, tablet PC, notebook or any other wireless electronic device that establishes communication with the TV display system using Wi-Fi or any other wireless transmission protocol.

It is still another object of the present invention to provide a TV and wireless electronic device combination system, which allows one wireless electronic device to control the operation of multiple TV monitors synchronously.

To achieve these and other objects of the present invention, a TV and wireless electronic device combination system comprises at least one TV monitor, each TV monitor comprising a TV display system, at least one wireless electronic device, a data stream connected between the at least one wireless electronic device and the TV display system of each TV monitor using Wi-Fi (Wireless Fidelity) or data packet transmission technology, wherein the TV display system of each TV monitor comprises a CPU adapted to process the data stream.

Further, the TV display system of each TV monitor further comprises a wireless communication module electrically connected to the CPU and adapted to establish a communication protocol interface with the at least one wireless electronic device for reading radio frequency signals, a power management device electrically connected to the CPU for power supply management, a DSP (data signal processor) electrically connected to the CPU for sound volume control and signal processing, an image mixing/switching device electrically connected to the CPU for mixing and switching images, and a Wi-Fi receiver and decoder device electrically connected to the CPU for decoding signals.

Further, the wireless communication module provides the function of an access point or router to establish a wireless network environment.

Further, the TV display system of each TV monitor further comprises a mirror image transmission device built in the CPU and adapted to display the current system operating mode and play state, enabling a mirror image of the picture of the respective TV monitor to be displayed on the screens of other wireless electronic devices.

Further, the mirror image transmission device has built therein an automatic transcoding software adapted to transcode audio and video signals into compressed data for outputting into slave wireless electronic devices using Wi-Fi (Wireless Fidelity) or data packet transmission technology. The target wireless electronic devices use a mating media player to reproduce received audio and video.

Further, the mirror image transmission device allows for input of a multimedia equipment being electrically connected to the respective TV monitor.

Further, the at least one multimedia equipment comprises at least one of DVD player, game machine, set-top-box and amplifier.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating a system architecture of a TV and wireless electronic device combination system in accordance with the present invention.

FIG. 2 is a circuit block diagram of the TV display system of the TV monitor of the TV and wireless electronic device combination system in accordance with the present invention.

FIG. 3 is a block diagram illustrating the operation flow of the receiver and decoder device of the TV display system of the TV and wireless electronic device combination system in accordance with the present invention.

### DETAILED DESCRIPTION OF THE PREFERRED EMBODIMENT

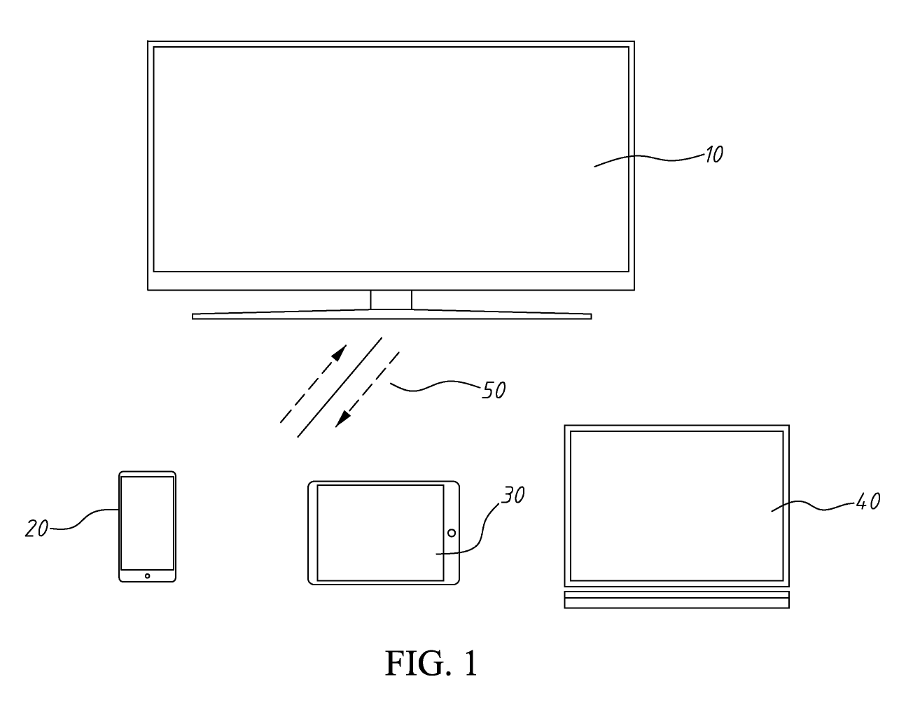

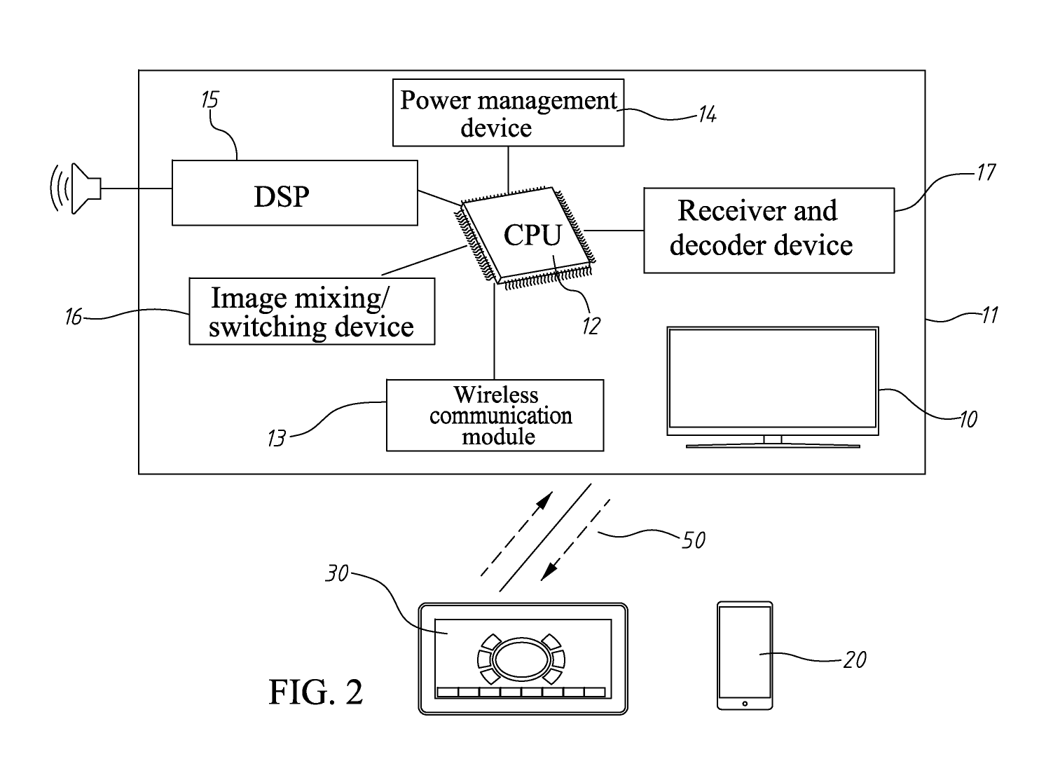

Referring to FIGS. 1 and 2, a TV and wireless electronic device combination system in accordance with the present invention is shown comprising a TV monitor 10 having built therein a TV display system 11 (see FIG. 2), and a master wireless electronic device, for example, but not limited to, smart phone 20, tablet computer 30 or notebook 40 for controlling the operation of the TV monitor 10 by a data stream 50 using Wi-Fi (Wireless Fidelity) or data packet transmission technology. The data stream 50 contains data, command, image, audio and mirror.

Referring to FIG. 2, the TV display system 11 of the TV monitor 10 comprises a CPU 12, a wireless communication module, for example, Wi-Fi chips 13, a power management device 14, a DSP (data signal processor) 15, an image mixing/switching device 16, and a receiver and decoder device 17 that is configured subject to Wi-Fi protocol or any other wireless standard. The CPU 12 is a memory and math function integrated device capable of running an operating system (for example, Linus or Android) and related micro application software (for example, R1/M1 MP3 player) and having built therein a ROM (read only memory) or RAM (random access memory). The wireless communication module (Wi-Fi chips) 13 is electrically coupled to the CPU 12, and adapted to establish a communication protocol interface with an IC of the master wireless electronic device (smart phone 20, tablet computer 30 or notebook 40) for reading radio frequency signals. Subject to the functioning of an application software and an operating system, the wireless communication module (Wi-Fi chips) 13 can provide the function of an access point or router to establish a wireless network environment.

The power management device 14, the DSP (data signal processor) 15, the image mixing/switching device 16 and the receiver and decoder device 17 are respectively electrically coupled to the CPU 12.

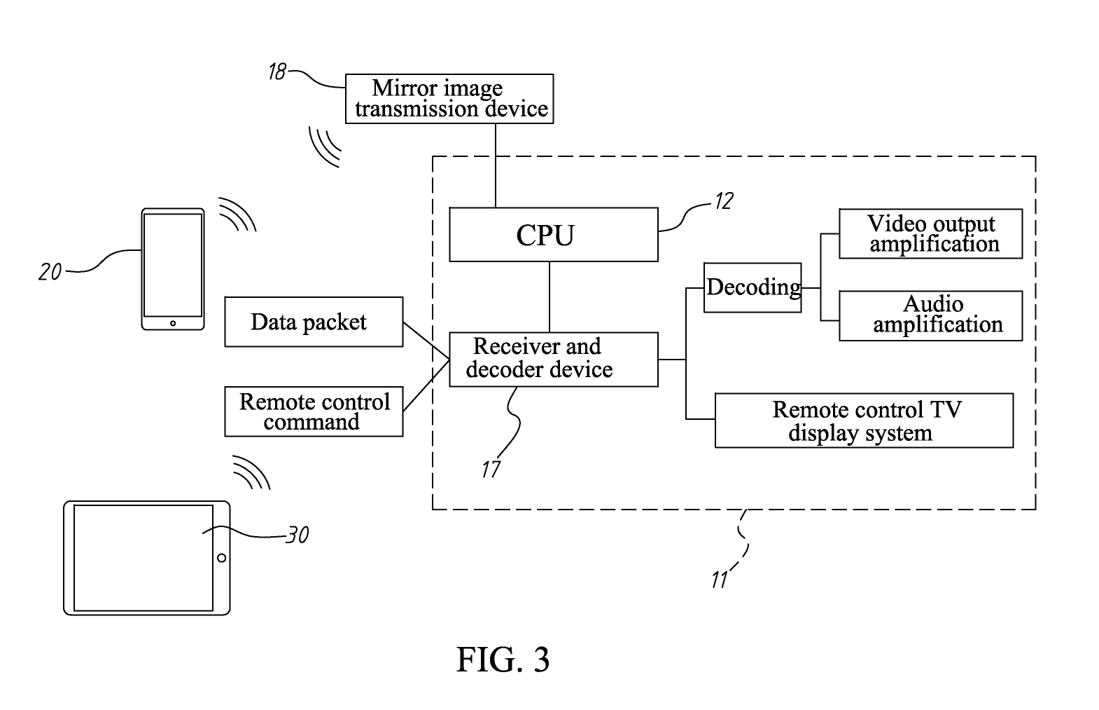

Referring to FIG. 3, during application, a user can operate a smart phone 20, tablet computer 30 or notebook 40 to transmit a data stream 50, which contains, for example, image and audio data, to the TV display system 11 of the TV monitor 10 subject to the Wi-Fi (Wireless Fidelity) protocol or a predetermined data packet transmission technology (see FIG. 1), enabling the data stream 50 to be outputted through the TV display system 11. The data stream 50 transmitted by the smart phone 20, tablet computer 30 or notebook 40 to the TV display system 11 is received by the wireless communication module (Wi-Fi chips) 13, and then decoded amplified by the receiver and decoder device 17 subject to the control of the CPU 12, enabling the amplified audio and video to be outputted by the TV display system 11.

In the aforesaid application example, data stream 50 transmitted by the master wireless electronic device, for example, smart phone 20, tablet computer 30 or notebook 40, to the TV display system 11 is received, decoded and amplified by the receiver and decoder device 17. Subject to the application of a control application software, the user can operate the smart phone 20, tablet computer 30 or notebook 40 to transmit a command to the TV display system 11, controlling the operation of the TV display system 11.

Further, a mirror image transmission device 18 is built in the CPU 12 of the TV display system 11 to display the current system operating mode and play state, enabling a mirror image of the picture of the TV monitor 10 to be displayed on the screens of slave wireless electronic devices, such as smart phones 20, tablet computers 30, notebooks 40, personal computers, etc., i.e., audio and video data can be synchronously transmitted to multiple slave wireless electronic devices for output.

Further, the output signal audio and video of the TV monitor 10 are linked in series. The aforesaid mirror image transmission device 18 allows for input of all video and audio the user seen and heard from the TV monitor 10. Further, the mirror image transmission device 18 has built therein an automatic transcoding software adapted to transcode audio and video signals into compressed data for outputting into other wireless electronic devices (smart phones, tablet PCs, notebooks, etc.) using Wi-Fi (Wireless Fidelity) or data packet transmission technology. The target wireless electronic devices use a mating media player to reproduce received audio and video. Thus, people can synchronously watch the same video on multiple slave wireless electronic devices at different locations.

Further, multimedia equipments, such as DVD player, game machine (PS3, Wii, Xbox 360), set-top-box, amplifier and the like can be connected to the TV monitor 10, enabling the master wireless electronic device to control the operation of the multimedia equipments, such as DVD player, game machine (PS3, Wii, Xbox 360), set-top-box, amplifier and the like that are connected to the TV monitor 10. In this case, the multimedia equipment of the TV monitor 10 is the set ISD (On-Screen Display), and the application software of the master wireless electronic device can transmit a command to the TV display system 11 of the TV monitor 10 to control the operation of the multimedia equipment.

The invention allows wireless transmission between a wireless electronic device and a TV monitor, having the advantages of ease of operation and low cost. Subject to the advantage of built-in design, a consumer can use his or her personal mobile electronic device to control the operation of a TV monitor that is constructed according to the present invention.

Although a particular embodiment of the invention has been described in detail for purposes of illustration, various modifications and enhancements may be made without departing from the spirit and scope of the invention. Accordingly, the invention is not to be limited except as by the appended claims.

1. A TV and wireless electronic device combination system, comprising at least one TV monitor, each said TV monitor comprising a TV display system, at least one wireless electronic device, a data stream connected between said at least one wireless electronic device and the TV display system of each said at least one TV monitor using Wi-Fi (Wireless Fidelity) or data packet transmission technology, wherein the TV display system of each said at least one TV monitor comprises a central processing unit adapted to process said data stream.

2. The TV and wireless electronic device combination system as claimed in claim 1, wherein the TV display system of each said at least one TV monitor further comprises a wireless communication module electrically connected to said central processing unit and adapted to establish a communication protocol interface with said at least one wireless electronic device for reading radio frequency signals, a power management device electrically connected to said central processing unit for power supply management, a DSP (data signal processor) electrically connected to said central processing unit for sound volume control and signal processing, an image mixing/switching device electrically connected to said central processing unit for mixing and switching images, and a Wi-Fi receiver and decoder device electrically connected to said central processing unit for decoding signals.

3. The TV and wireless electronic device combination system as claimed in claim 2, wherein said wireless communication module provides the function of an access point to establish a wireless network environment.

4. The TV and wireless electronic device combination system as claimed in claim 2, wherein said wireless communication module provides the function of router to establish a wireless network environment.

5. The TV and wireless electronic device combination system as claimed in claim 1, wherein the TV display system of each said at least one TV monitor further comprises a mirror image transmission device built in said central processing unit and adapted to display the current system operating mode and play state, enabling a mirror image of the picture of the respective TV monitor to be displayed on the screens of slave wireless electronic devices.

6. The TV and wireless electronic device combination system as claimed in claim 2, wherein the TV display system of each said at least one TV monitor further comprises a mirror image transmission device built in said central processing unit and adapted to display the current system operating mode and play state, enabling a mirror image of the picture of the respective TV monitor to be displayed on the screens of slave wireless electronic devices.

7. The TV and wireless electronic device combination system as claimed in claim 3, wherein the TV display system of each said at least one TV monitor further comprises a mirror image transmission device built in said central processing unit and adapted to display the current system operating mode and play state, enabling a mirror image of the picture of the respective TV monitor to be displayed on the screens of slave wireless electronic devices.

8. The TV and wireless electronic device combination system as claimed in claim 4, wherein the TV display system of each said at least one TV monitor further comprises a mirror image transmission device built in said central processing unit and adapted to display the current system operating mode and play state, enabling a mirror image of the picture of the respective TV monitor to be displayed on the screens of slave wireless electronic devices.

9. The TV and wireless electronic device combination system as claimed in claim 5, wherein said mirror image transmission device has built therein an automatic transcoding software adapted to transcode audio and video signals into compressed data for outputting into slave wireless electronic devices using Wi-Fi (Wireless Fidelity) or data packet transmission technology. The target wireless electronic devices use a mating media player to reproduce received audio and video.

10. The TV and wireless electronic device combination system as claimed in claim 5, wherein said mirror image transmission device allows for input of a multimedia equipment being electrically connected to the respective TV monitor.

11. The TV and wireless electronic device combination system as claimed in claim 7, wherein said at least one multimedia equipment comprises at least one of DVD player, game machine, set-top-box and amplifier.
